(19) United States
(12) Patent Application Publication
(10) Pub. No.: US 2009/0044518 A1
(43) Pub. Date: Feb. 19, 2009

(54) SULPHUR OXIDE (SOX) REMOVAL METHOD AND SYSTEM AND CONTROLLER FOR SAID SYSTEM

(75) Inventors: Benoit Frouvelle, Paris (FR); Arnaud Audouin, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/278,575

(22) PCT Filed: Feb. 1, 2007
(86) PCT No.: PCT/FR07/50727

§ 371 Date: Aug. 6, 2008

(30) Foreign Application Priority Data
Feb. 9, 2006 (FR) 0601163

(51) Int. Cl. F01N 3/20; F02D 41/02; B01D 53/60

(52) U.S. Cl. 60/286; 423/242.1; 60/300; 701/103; 123/672

(57) ABSTRACT

This system for the elimination of SOx (Sulphur Oxide) stored in a NOx (24) (Nitrogen Oxide) trap associated with an oxidation catalyst and placed upstream of a particle filter (26) in an exhaust line of a motor vehicle engine comprises a feed supervisor (32) able only to trigger the execution of an operation to flush out the NOx trap and cancel the execution of an operation to regenerate the particle filter, when the flushing out operation is to be performed immediately before or after the regeneration operation.

The present invention relates to a system and a method for removing SOx (Sulfur Oxide), and a supervisor for this system.

Traditionally, a motor vehicle diesel engine is associated with means for treating its exhaust gases so as to reduce the quantity of pollutants released into the atmosphere, and particularly, the quantity of nitrogen oxide, or NOx molecules.

To this end, the engine can be associated with a NOx trap arranged in the exhaust line thereof and designed to store such molecules in the form of nitrates at specific storage sites, such as barium, for example.

In order to regenerate the NOx trap, a fueling device for the engine is switched over to rich mixture so that the engine will release a sufficient quantity of reducers for the NOx contained in the trap, such as HC and CO, into the exhaust line. The NOx is then reduced and desorbed in the form of N₂, and the storage sites are made available for new NOx storage.

These storage sites are also capable of storing sulfur oxides, or SOx, when they are exposed to SO₂ generated by the engine from sulfur contained in the fuel and the engine lubrication oil. The trap thus becomes progressively saturated with SOx, which reduces its catalytic performance.

Thus, it is necessary to purge the trap regularly in order to remove the SOx stored therein.

Because of the high thermodynamic stability of SOx, simply switching to the engine's rich mode is not enough to reduce the latter. For this purpose, the temperature of the trap must also be raised to high levels, greater than 650° C.

To this end, the NOx trap is generally associated with a catalyst arranged upstream of or built onto the same support as the trap. The catalyst is adapted to burn hydrocarbons originating from the engine, and thereby generate exotherms in order to raise the temperature of the trap.

Nowadays, some motor vehicles are also equipped with a particulate filter placed downstream of the NOx trap in the exhaust line.

Thus, there are systems for removing SOx stored in a NOx trap comprising a fuel supply controller adapted to execute multiple tasks, including at least:
a regeneration cycle activated in response to receiving a regeneration request, this cycle consisting in commanding a device for supplying fuel to the engine cylinders so as to supply the engine with a rich mixture that enables the particulate filter to be regenerated without thereby allowing the SOx to be removed from the NOx trap, and
a NOx trap purge cycle activated in response to receiving a purge request, this cycle consisting in commanding the fuel supply device to supply the engine with a lean mixture that makes it possible to raise the temperature inside the NOx trap and maintain it within a temperature range where SOx removal becomes possible, alternating with a rich mixture that enables the SOx stored in the NOx trap to be removed.

The purge cycle and the particulate filter regeneration cycle require an increase in the temperature inside the NOx trap and the particular filter, respectively, and thus they consume energy.

Nowadays, it is desirable to reduce energy consumption as well as the harmful effects of these heating phases.

The invention thus aims to remedy these disadvantages by proposing a SOx removal system that makes it possible to reduce energy consumption.

An object of the invention is thus a system for removing SOx stored in a NOx trap in which, when a purge cycle must be executed immediately before or after a regeneration cycle, the fuel supply controller is adapted to activate only the execution of the purge cycle, and to cancel the execution of the regeneration cycle.

Running the purge cycle results in enough heating of the exhaust gases in order to also trigger the regeneration of the particulate filter. Because of this, it is not necessary to execute the regeneration cycle immediately preceding or following the purge cycle, as this is pointless. Thus, this makes it possible to reduce the energy consumption of the motor vehicle.

The embodiments of this system can include one or more of the following characteristics:
the fuel supply controller is adapted to transmit to the particulate filter supervisor, each time a purge cycle is executed, an information unit indicating that a purge cycle has been executed, this information altering the instant or the content of the next regeneration request generated by the particulate filter supervisor;
a purge request generator adapted to set the value of a degree of urgency assigned to the purge cycle, with this degree of urgency adapted to take at least two different values, i.e., a value corresponding to a low level of urgency and a value corresponding to a higher level of urgency, and to associate the degree of urgency established with the purge request being sent to the fuel supply controller, and in which the fuel supply controller is adapted to plan the instant at which the purge cycle is executed according to the degree of urgency received;
the fuel supply controller is adapted to immediately execute the purge cycle in response to receiving a purge request associated with a degree of urgency whose value is greater than a preset threshold;
the fuel supply controller is adapted to execute a regeneration cycle only if no purge cycle must be executed immediately after or before;
the fuel supply controller is adapted to delay running the purge cycle until it receives a regeneration request for the particulate filter, and in response to this regeneration request, to activate only the purge cycle;
the fuel supply controller is adapted to delay running the particulate filter regeneration cycle until it receives a purge request, and in response to this purge request, to activate only the purge cycle;

These embodiments of the SOx removal system additionally offer the following advantages:
having the particulate filter supervisor use information that a purge cycle has been executed enables this supervisor to refrain from sending needless regeneration requests,
assigning a degree of urgency to the purge cycle increases flexibility in planning the cycles that the fuel supply controller must execute,
immediately executing the purge cycle if the degree of urgency crosses a preset threshold makes it possible to continually keep the NOx trap operating correctly,
delaying the execution of the purge cycle makes it possible to cancel a regeneration cycle that would have immediately followed this purge cycle,
delaying the execution of a regeneration cycle makes it possible to cancel this regeneration cycle if it is immediately followed by a purge cycle.

Another object of the invention is a fuel supply controller that can be implemented in the above-mentioned SOx removal system.

Another object of the invention is a method for removing SOx stored in a NOx trap associated with an oxidation catalyst and placed upstream of a particulate filter in an exhaust line of a motor vehicle engine, upstream being defined as the direction going toward the source of the exhaust gases, this method comprising steps consisting in:
executing a regeneration cycle activated in response to receiving a regeneration request, this cycle consisting in commanding a device for supplying fuel to the engine cylinders so as to supply the engine with a rich mixture that enables the particulate filter to be regenerated without thereby allowing the removal of SOx stored in the NOx trap, and
executing a purge cycle activated in response to receiving a purge request, this cycle consisting in commanding the fuel supply device to supply the engine with a lean mixture that makes it possible to raise the temperature inside the NOx trap to a temperature at which SOx removal becomes possible, alternating with a rich mixture that enables the SOx to be removed.

When a purge cycle must be executed immediately before or after a regeneration cycle, the method has a planning stage for the tasks to be executed, in which the purge cycle is activated, while the regeneration cycle is canceled.

Lastly, another object of the invention is an information recording medium containing instructions for executing the SOx removal method when said instructions are executed by an electronic computer.

The invention will be more easily understood from the following description, given only as a non-limiting example, and written with reference to the drawings, in which:

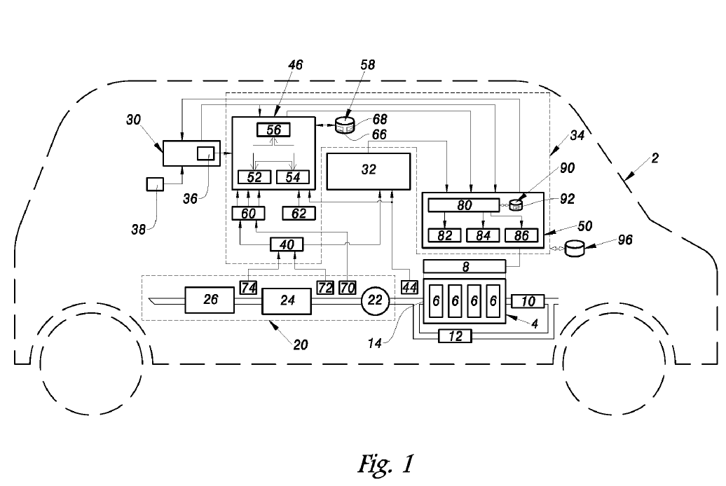

FIG. 1 is a schematic illustration of the architecture of a system for removing SOx stored in a NOx trap of a motor vehicle.

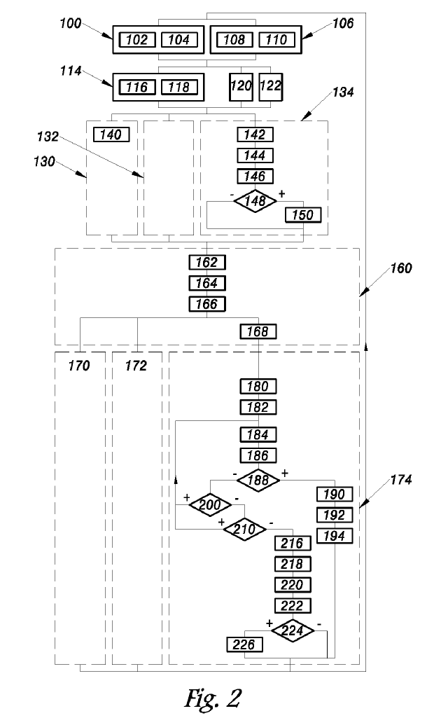

FIG. 2 is a schematic illustration of a flow chart of a SOx removal method using the system in FIG. 1, and

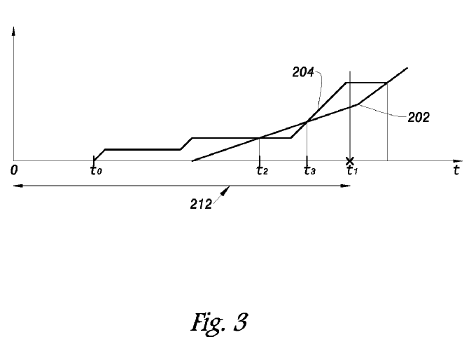

FIG. 3 is a signal timing diagram for the system in FIG. 1.

FIG. 1 shows a motor vehicle 2 equipped with a heat engine 4 for driving the rotation of the drive wheels of the vehicle. For example, the engine 4 is a diesel engine.

In the rest of this description, the characteristics and functions that are well known to the person skilled in the art are not described in detail.

The engine 4 is equipped with cylinders 6 that have pistons moving inside them for driving the rotation of a camshaft.

The engine 4 is associated with a controllable device 8 for supplying fuel to the cylinders 6.

The engine 4 is also associated with an intake device 10 for admitting an air/exhaust gas mixture into the cylinders 6. This mixture is obtained by mixing fresh air with the exhaust gases produced by the engine 4. To this end, the device 10 is fluidly linked to an exhaust gas recirculation device 12, better known by the term “EGR device” (Exhaust Gas Recirculation). This device 12 is fluidly linked to an exhaust gas output 14. The output 14 is also fluidly linked to an exhaust line 20 allowing the exhaust gases to be vented outside the vehicle 2.

This exhaust line 20 is equipped, in upstream to downstream order, with a turbocompressor 22, a NOx trap 24, and a particulate filter 26.

Here, the NOx trap 24 also functions as an excitation catalyst through the inclusion of a catalyst-forming means on its support. This catalyst is adapted to generate exotherms in order to raise the temperature of the trap.

The vehicle 2 is also equipped with a supervisor 30 for the particulate filter 26, a supervisor 32 for regenerating the trap 24, and a system 34 for removing the SOx stored in the trap 24.

The supervisor 30 is adapted to generate a regeneration request designed to activate a regeneration cycle for the particulate filter 26. In this embodiment, this supervisor 30 also includes an estimator 36 of the type of driving for the vehicle 2. Here, for example, the type of driving can take three different values, namely, the values “URBAN”, “RURAL”, and “FREEWAY”. The value “URBAN” indicates that the vehicle 2 driving conditions resemble the driving conditions for a vehicle in town. The value “RURAL” indicates that the vehicle 2 driving conditions resemble those encountered on a state highway. Lastly, the value “FREEWAY” indicates that the vehicle 2 driving conditions are those encountered on a freeway. The estimator 36 establishes the type of driving from various operating condition sensors on the vehicle 2, including in particular a vehicle 2 speed sensor 38.

Here, the values “URBAN”, “RURAL”, and “FREEWAY” are respectively associated with three numerical values ranked in increasing order, in such a way that a particular type of driving can be distinguished by comparison with a predetermined threshold.

The supervisor 32 is adapted to generate and send a request for regeneration of the trap 24 when it is necessary to remove the NOx stored in the trap 24. The sending of this request is activated, for example, as a function of:
an estimate of the temperature TNOx inside the trap 24, provided by an estimator 40, and
a measurement representing the engine 4 operating temperature. For example, this measurement is provided by an engine 4 coolant temperature sensor 44.

The system 34 includes a supervisor 46 for purging the trap 24, as well as a fuel supply controller 50 adapted to control the device 8.

The supervisor 46 includes:
a purge request generator 52 for the trap 24,
a trap 24 purge shut-off module 54, and
a timer 56 adapted to count down a preset time interval from the moment it is activated.

The supervisor 46 is also linked to information storage means such as a memory 58, to an estimator 60 of SOx poisoning in the trap 24, to an estimator 62 of the level of engine 4 oil dilution, and to the sensor 44.

The memory 58 is intended to store various variables used in the execution of the method of FIG. 2. In particular, the memory 58 includes:
a variable “deSOx dwell incomplete”, whose value is “true” as long as the timer 56 has not finished counting down the preset time interval.
a variable “successive deSOx failure count”, which gives the number of purge cycles successively launched and not completed.
a variable “deSOx condition critical”, which takes the value “true” to indicate that the current trap 24 operating conditions make it difficult to complete a purge cycle, and which otherwise takes the value “false”, and
the variable “deSOx unfavorable”, which takes the value “true” when the trap 24 purge cycle currently being run is inefficient, and otherwise takes the value “false”.

The variable “deSOx unfavorable” corresponds to a degree of efficiency of the purge cycle, with two possible states.

The memory 58 also includes a rule base 66 used by the generator 52 to generate the purge request, and a rule base 68 used by the module 54 to command the purge to shut off.

These rule bases 66 and 68 are itemized below.

The estimator 60 is adapted to transmit a SOx poisoning level indicator for the trap 24. Here, this indicator can take five different values: “LOW”, “MEDIUM”, “HIGH”, “VERY HIGH”, and “CRITICAL”, respectively.

The estimator 60 is also adapted to transmit an instantaneous rate VdeSOx of SOx removal from the trap 24 while the purge cycle is being executed, and an estimate of the SOx mass mSOx currently stored in the trap 24. The value of this indicator and of these various estimates are established, for example, from the estimate TNOx of the temperature inside the trap 24 and from information provided by a proportional λ probe 70 for measuring the richness of the mixture entering the trap 24.

More precisely, the estimator 60 continuously calculates the SOx mass stored in the trap 26. For example, to this end, two different calculations are performed. That is, one of these calculations pertains to the SOx storage rate, and the other to its release rate VdeSOx. According to whether a purge cycle is in progress or not, a switch takes one of the two rates for integration in order to continuously estimate the SOx mass mSOx in the trap.

The SOx storage rate calculation is in fact the sum of two storage rates, i.e., the rate due to the sulfur contained in the fuel consumed by the engine, and the rate due to the sulfur contained in the lubrication oil consumed by the engine.

The storage rate for the SOx coming from the fuel consumed by the engine is calculated assuming that the fuel sulfur content is constant, i.e., at 10 ppm, for example. The instantaneous fuel consumption by the engine (Qcarb) is determined by adding together the flow rates of the various injections being used, namely the pilot (Qpilotᵢ), main (Qmainᵢ) and post-injections (Qpostᵢ), according to the relation:

Qcarb(g/s)=(0.835/3*10⁴)*(Qpilotᵢ+Qmainᵢ+Qpostᵢ(mm3/cp))*Nᵢ(rpm)

in which N represents the engine rotation speed.

This instantaneous fuel consumption is then multiplied by the fuel sulfur content, which yields the storage rate due to fuel.

The storage rate for sulfur coming from the oil consumed by the engine is calculated from the engine oil consumption, which is a value that is calibratable, e.g., in g/1000 km driven, multiplied by the oil sulfur content, which is also a calibratable value.

This storage rate is then determined by the relation:

(Oil sulfur content [ppm])*(Oil consumption [g/1000 km]/1000)*(Vehicle speed [km/h]/3600).

The total sulfur storage rate is thus the sum of the rate from fuel and the rate from lubrication oil.

The release rate VdeSOx, for its part, is calculated when a purge cycle is executed. The SOx mass mSOx in the trap 24 decreases each time the engine goes into rich burn mode. Then a predetermined release model is used to represent the change over time in the mass mSOx during the purge cycle. This model is adapted to provide an estimate of the rate VdeSOx (g/s) as a function of the richness value of the gases, as provided by the proportional lambda probe 70, and the temperature inside the trap 26, estimated by the estimator 40.

Next, the mass mSOx is compared to various thresholds—that are preset, for example—in order to estimate a level of poisoning in the pollution control means.

Thus, for example, this mass can be compared to four preset thresholds for defining five levels of poisoning, namely, a low level, a medium level, a high level, a very high level, and a critical level of poisoning, with the corresponding level being transmitted to the supervisor 46 and factored into the decision to turn on or shut off a purge cycle.

The estimator 62 estimates the oil dilution value from charts of oil dilution by fuel and fuel evaporation during operation of the engine in its various modes, and from the time during which this engine operates in each mode.

For example, an hourly oil dilution estimation module and an hourly oil evaporation estimation module are used for this.

For example, these modules take the form of preestablished dilution and evaporation charts in the tuning of the engine and associated pollution control means, which receive as input various information about the engine operating conditions, such as engine rotation speed, fuel flow, and engine operating mode information, for example.

The evaporation module also receives oil temperature and overall oil dilution rate information as input.

Thus, the dilution chart is established from the engine speed, the flow rate and the operating mode, whereas the evaporation chart is established from the engine speed, the flow rate, the operating mode, the oil temperature and the overall dilution rate.

Using the various parameters listed above, it is thus possible to obtain the hourly oil dilution and evaporation values, which are charted.

This way, a cumulative dilution value D-acc can be derived based on a vehicle driving period as a function of the time spent at each preset engine operating point.

Likewise, a cumulative evaporation value E-acc can be derived based on the vehicle driving period as a function of the time the engine spends at each operating point.

This is done through corresponding accumulators that cumulate the values for dilution and evaporation over time, with the overall dilution D-global being calculable from the difference between the cumulative dilution D-acc and the cumulative evaporation E-acc.

The values obtained for overall dilution D-global are then compared to preset thresholds in order to assign a dilution rate, for example, with four different values, i.e., “low”, “medium”, “high”, and “critical”.

By way of illustration, the estimator 40 establishes the TNOx estimate using two exhaust gas temperature sensors 72 and 74, upstream and downstream, respectively, of the trap 24.

The base 66 includes rules that make it possible to establish the value of a degree of urgency assigned to the trap 24 purge cycle as a function of the estimates made by the estimators 36, 60, 62 and the temperature measured by the sensor 44. In this embodiment, the rules in the base 66 are as follows, for example:

Rule 0:

The value of the degree of urgency is equal to “0” when none of the following rules applies. In this case, it is not necessary to plan a purge cycle, and no purge request is transmitted to the supervisor 50.

Rule 1:

The value of the degree of urgency is equal to “1” when:
(the dilution rate is equal to “low” or “medium” or “high”)

AND
(the temperature measured by the sensor 44 is greater than a preset threshold)

AND
(the variable “deSOx dwell incomplete” is equal to “false” and the variable “deSOx condition critical” is equal to “false”)

AND
(the poisoning level is equal to “medium” or “high”) or (the poisoning level is equal to “very high” and the type of driving is less than a preset threshold)

When the degree of urgency is equal to “1”, this means that the sulfur poisoning level is beginning to be significant, but the need is not actually urgent. This also covers the scenario in which the poisoning level is equal to “very high”, but the driving conditions are not favorable for running a purge cycle. In the latter case, the value of the degree of urgency is kept equal to “1”, so as not to precipitate the activation of this purge cycle.

Rule 2:

The degree of urgency is equal to “2” if:
(the dilution rate is equal to “low” or “medium” or “high”)

AND
(the temperature measured by the sensor 44 is greater than a preset threshold)

AND
(the variable “deSOx condition critical” is equal to “false”)

AND
(the poisoning level is equal to “very high” and the type of driving is greater than a preset threshold)

When the degree of urgency is equal to “2”, this means that the trap 24 has a pronounced level of poisoning and that the vehicle 2 driving conditions are favorable for running a purge cycle. The need to run this purge cycle is therefore justified, but not vital nor extremely urgent. In particular, it can be seen that there is no longer a condition on the variable “deSOx dwell incomplete” in rule 2. That is, the identification of favorable driving conditions allows for the possibility that the purge cycle may be successfully completed, even if it failed previously.

Rule 3:

The degree of urgency is equal to “3” if:
(the dilution level is equal to “low” or “medium” or “high”)

AND
(the temperature measured by the sensor 44 is greater than a preset threshold)

AND
(the variable “deSOx condition critical” is equal to “false”)

AND
(the poisoning level is equal to “critical”).

When the degree of urgency is equal to “3”, the trap has a critical poisoning level.

Thus, for the sake of its lifespan and to prevent irreversible degradation, it is vital to command a purge cycle to be urgently executed.

Rule 4:

The degree of urgency is equal to “4” if:
(the dilution level is equal to “low” or “medium” or “high”)

AND
(the temperature measured by the sensor 44 is greater than a preset threshold)

AND
(the variable “deSOx condition critical” is equal to “true”)

AND
(the type of driving is greater than a preset threshold).

The degree of urgency is equal to “4” when the supervisor 46 has detected a certain number of failed purge cycle runs (the variable “deSOx condition critical” has changed from “false” to “true” in value). This means that the supervisor 46 is experiencing significant difficulties in executing the purge cycle efficiently. Consequently, looking out for the slightest favorable condition becomes a matter of urgency, in order to try to complete this purge cycle. The degree of urgency therefore takes the value “4” as soon as the driving conditions are favorable, regardless of the quantity of SOx in the trap 24. The failure of the preceding purge cycles means that the driving conditions are rarely favorable, and it is thus wise to set the degree of urgency to the value “4” in order to seize the moment when the driving conditions finally become favorable.

Note that the degree of urgency systematically takes the value “0” when:
the engine is cold (which corresponds to a temperature measured by the sensor 44 less than the preset threshold). That is, in such conditions, the purge cycle cannot be brought to completion.
the dilution rate is equal to “critical”. That is, engine behavior is given priority here over the lifespan and degradation of the trap 24.

The base 68 includes rules that make it possible to determine whether a purge cycle shut-off command must be transmitted. For example, the base 68 includes the following rules:

Rule 5:

If the mass mSOx estimated by the estimator 60 reaches the value zero, then the purge cycle must be shut off.

Rule 6:

If the rate VdeSOx estimated by the estimator 60 becomes less than a preset threshold, then assign the value “true” to the variable “deSOx condition unfavorable”, unless a filter 26 regeneration cycle must be executed at the same instant.

In this embodiment, rather than comparing the rate VdeSOx to a preset threshold, this rate VdeSOx is integrated from the beginning of the purge cycle in order to obtain a mass mdeSOx removed since the beginning of the purge cycle, and this mass mdeSOx is compared to a preset threshold whose value increases over time from the beginning of the purge cycle.

In addition, the supervisor 46 is linked to the supervisor 30 so as to receive the information used to execute a filter 26 regeneration cycle.

A more precise example of the use of rule 6 will be given with respect to FIG. 3.

The supervisors 30, 32 and 46 are linked to the supervisor 50 in such a way that the latter can receive the regeneration requests for the trap 24 and the filter 26, as well as the purge requests and the purge cycle shut-off commands. The supervisor 50 is also adapted to notify the supervisor 30 that a purge cycle has been run.

The supervisor 50 includes a common decision module 80 that receives the regeneration and purge requests and is adapted to schedule the instants at which the regeneration and purge cycles can be executed according to these requests. This module 80 is adapted to activate a filter 26 regeneration controller 82, a trap 24 purge controller 84, and a trap 24 regeneration controller 86. The controllers 82 and 86 are adapted to command the fuel supply device 8 using a predetermined strategy in order to activate and execute a regeneration cycle for the filter 26 and the trap 24, respectively. For example, the trap 24 regeneration cycle can be run in accordance with the teaching of patent EP 0 859 132.

The controller 84 is adapted to command the device 8 in order to execute the trap 24 purge cycle. For example, this purge cycle is executed in accordance with the teaching of patent application FR 04 07884, filed on 15 Jul. 2004 in the name of PEUGEOT CITROEN AUTOMOBILES SA.

The common decision module 80 is also associated with information storage means such as a memory 90 containing a rule base 92.

The base 92 contains rules that make it possible to schedule and plan the execution of the regeneration and purge cycles.

For example, the rules that make it possible to schedule and plan the execution of the filter 26 regeneration and trap 24 purge cycles are the following:

Rule 7:

When no regeneration or purge request is received by the supervisor 50, then no filter 26 regeneration or trap 24 purge cycle is executed.

Rule 8:

When a filter 26 regeneration request is received and no purge request is received, then run a filter 26 regeneration cycle and do not run a trap 24 purge cycle.

Rule 8 makes it possible to begin running a filter 26 regeneration cycle only if no trap 24 purge cycle must be run.

Rule 9a:

If only a purge request with a degree of urgency equal to “1” has been received, then delay starting the trap 24 purge cycle.

In other words, if the degree of urgency assigned to the purge cycle is not very high, then the execution of this cycle is postponed.

Rule 9b:

If a filter 26 purge request is received, and the execution of the purge cycle was postponed, then execute only the purge cycle and cancel the regeneration cycle corresponding to the regeneration request that was received.

That is, due to the increase in the exhaust gas temperature triggered by the purge cycle, this cycle also simultaneously triggers the regeneration of the filter 26. This rule 9b thus makes it possible to avoid running a filter 26 regeneration cycle immediately before or immediately after a purge cycle. This reduces fuel consumption as well as wear on the filter 26.

Rule 10:

If the purge request has a degree of urgency equal to “2”, “3” or “4”, then immediately execute a purge cycle only.

That is, the degree of urgency being equal to “2”, “3”, or “4” means that it is urgent to purge the trap 24 without waiting for a filter 26 regeneration request to be received.

By way of example, the SOx removal system 34 is embodied using a programmable electronic computer adapted to execute instructions recorded on an information recording medium 96. To this end, the recording medium 96 has instructions for executing the method of FIG. 2 when these instructions are executed by the electronic computer.

The operation of the system 34 will now be described in more detail with respect to the method of FIG. 2.

Initially, in a step 100, the engine 4 operating conditions are measured. For example, in this step 100, the engine 4 coolant temperature is measured by the sensor 44 in an operation 102, and the vehicle 2 speed is measured by the sensor 38 in an operation 104.

Concurrently, in a step 106, the exhaust line 20 operating conditions are also measured. For example, in step 106, the temperatures upstream and downstream of the trap 24 are measured by the sensors 72 and 74 in an operation 108, and the richness of the gas mixture upstream of the trap 24 is measured by the probe 70 in an operation 110.

Next, in a step 114, the operating conditions of the trap 24 are estimated from the various measurements taken. For example, in step 114, the temperature TNOx inside the trap 24 is estimated by the estimator 40 in an operation 116. It is also in this step 114 that the estimator 60 estimates the poisoning level in the trap 24, the rate VdeSOx, and the mass mSOx, in an operation 118.

Concurrently with step 114, in steps 120 and 122, the oil dilution rate and the type of driving for the vehicle are estimated by the estimators 62 and 36, respectively.

From these measurements and estimates, a filter 26 regeneration supervision phase 130, a trap 24 regeneration supervision phase 132, and a trap 24 purge supervision phase 134 are executed concurrently. These various supervision phases consist in sending a regeneration request or a purge request to the supervisor when necessary.

Since the trap 24 regeneration is supervised in a conventional manner, it will not be described in detail.

Likewise, phase 130 is conducted in a conventional manner, with the exception that the filter 26 regeneration request is generated, in an operation 140, taking into account that a purge cycle has been executed. That is, as previously noted, a purge cycle also leads to regeneration of the filter 26, and must therefore be considered as a filter 26 regeneration cycle by the supervisor 30 in order to correctly transmit the next regeneration request for this filter.

Phase 134, which leads to the transmission of a purge request to the supervisor 50, will now be described in more detail.

Initially, in a step 142, the generator 52 obtains the various estimates made by the estimators 36, 60 and 62, as well as the operating temperature measured by the sensor 44.

Next, in a step 144, it also obtains the values for the variables “deSOx dwell failed” and “deSOx condition critical”.

From the various information acquired in steps 142 and 144, in a step 146, the generator 52 establishes the degree of urgency to assign to the purge cycle by applying the rules defined in the base 66.

Next, in a step 148, if the value of the degree of urgency established is different from “0”, then, in a step 150, the generator 52 generates a purge request in which it incorporates the value of the degree of urgency established, and sends this purge request to the supervisor 50.

In the event that the degree of urgency established is equal to “0”, no purge request is sent to the supervisor 50.

Each time a request is sent by one of the supervisors, the supervisor 50 executes an engine 4 fuel supply supervision phase 160. More precisely, at the beginning of this phase 160, in a step 162, the supervisor 50 receives the requests transmitted by the supervisors 30, 32 and 46.

Next, in a step 164, the common decision module 80 schedules and plans the instants at which the regeneration and purge cycles triggered by the requests are executed. In step 164, the module 80 plans the execution of these cycles by applying the rules defined in the base 92. Next, in a step 166, the controllers 82, 84 and 86 are activated in order to execute the cycles planned in step 164.

In the event that a purge cycle must be run, before beginning its execution, in a step 168, the decision module 80 notifies the supervisor 30 so that this information can be taken into account in step 140.

If the controller 82 is activated, then it executes a filter 26 regeneration cycle in a phase 170.

If the controller 86 is activated, then it executes a trap 24 regeneration cycle in a phase 172.

Lastly, if the controller 84 is activated, then it executes a phase 174 to remove the SOx stored in the trap 24.

Phases 170 and 172 are carried out in a conventional manner, and will not be described here in more detail.

In phase 174, the device 8 is controlled so as to fuel the engine 4 initially using a lean first mixture that enables the temperature to increase inside the trap 24 to above 650° C. and, preferably, to above 700° C. Next, the device 8 is controlled so as to fuel the engine with a rich mixture that enables the SOx stored in the trap 24 to be removed. During this fueling with a rich fuel, the temperature inside the trap 24 decreases. From then on, these rich-fuel supply phases are alternated with lean-fuel supply phases so as to maintain the temperature inside the trap 24 at around 700°, and, for example, in a range between 650° and 750° C.

When phase 174 is activated, the module 54 monitors the progress of this phase so as to order the trap 24 purge cycle to shut off at the desired time by applying the rules in the base 68.

More precisely, in a step 180, at the moment the purge cycle begins to run, the module 54 assigns the value “false” to the variable “deSOx unfavorable”.

Also at the moment the purge cycle begins, in a step 182, the module 54 obtains the mass mSOx(t₀) of SOx stored in the trap 24 at that instant.

Next, in a step 184, the module 54 obtains the rate VdeSOx and the mass mSOx(t) at the current instant.

In a step 186, the rate VdeSOx is integrated over the time interval that has elapsed since the beginning of the purge cycle in order to obtain a mass mₛₜ(t) of SOx removed since the beginning of the purge cycle.

In a step 188, this mass mₛₜ(t) is compared to the mass mSOx(ₜₒ) acquired in step 182. If these masses are equal, this means that substantially all of the SOx has been removed from the trap 24, and the module 54 orders the purge cycle to shut off, in a step 190.

Next, in a step 192, the module 54 re-initializes the value of the variable “successive deSOx failure count” at zero, and assigns the value “false” to the variable “deSOx condition critical” in a step 194.

Phase 174 then ends, and the method returns to steps 100 and 106.

In the event that it is determined in step 188 that there is still a mass of SOx to remove from the trap 24, then in a step 200, the module 54 compares the mass mₛₜ(t) to a preset threshold that increases as a function of the time elapsed since the beginning of the purge cycle. This threshold is represented by a rising line 202 in the graph in FIG. 3. In this graph, a line 204 also represents an example of change over time in the mass mₛₜ(t).

In the graph in FIG. 3, instant to represents the instant the purge cycle begins to run.

If the mass mₛₜ(t) is less than the preset threshold, then in a step 210, the module 54 verifies whether a filter 26 regeneration cycle was called for, but not yet run to completion. In the example in FIG. 3, it is supposed that a filter 26 regeneration cycle has been called for starting at instant 0, and is not completed until instant t₁, as shown by the arrow 212.

If no filter 26 regeneration cycle has been called for, or if the latter is completely finished, and the mass mₛₜ(t) is less than the preset threshold, then in a step 216, the module 54 assigns the value “true” to the variable “deSOx unfavorable”, and then commands the purge cycle to shut off in a step 218. Actually, this means that the latter is running too slowly to be efficient. In these conditions, it is better to interrupt the purge cycle and resume it later, when the conditions for running this purge cycle are more favorable. This makes it possible to limit wear on the trap 24, the increase in the level of engine oil dilution by diesel fuel, and the overconsumption of fuel for the client, since the duration of the purge cycles is shortened.

At the end of step 218, the module 54 starts the timer 56 in a step 220. This timer 56 keeps the value of the variable “deSOx dwell incomplete” set at the “true” value for a preset time interval after an inefficient purge cycle has shut off. Next, in a step 222, the value of the variable “successive deSOx failure count” is increased by a preset increment.

The value of this counter is then compared to a preset threshold in a step 224. If this preset threshold is crossed, then in a step 226, the value “true” is assigned to the variable “deSOx condition critical”, and then the method returns to steps 100 and 106. Otherwise, the method returns directly to steps 100 and 106 without changing the value of the variable “deSOx condition critical”.

If it is determined in step 200 that the mass mₛₜ(t) is greater than the preset threshold, or if in step 210 it is determined that a regeneration cycle is in progress, then the module 54 does not command the purge cycle to shut off, and returns to step 184.

Thus, as illustrated in the graph in FIG. 3, between instants t₂ and t₃, the mass mₛₜ(t) is less than the preset threshold, but this does not trigger the shut-off of the purge cycle, because a regeneration cycle is currently in progress.

Many other embodiments of the system 34 are possible. For example, generating a purge request associated with a degree of urgency or commanding the purge cycle to shut off as described here can be implemented in a vehicle in which the exhaust line has no particulate filter, for example, but only a NOx trap.

Other methods can be used to estimate the dilution rate or the poisoning level in the trap 24 than those described herein. The same applies for estimating the type of driving. In particular, some of these estimators are replaced by sensors as a variant. Conversely, some sensors, e.g., sensor 44, are replaced by estimators as a variant.

The system 34 has been described here in the particular case where a degree of urgency is associated with the purge request in order to add a degree of flexibility to planning the cycles executed by the supervisor 50. As a variant, a degree of urgency for the filter 26 regeneration cycle is associated with the regeneration request transmitted by the supervisor 30. When a degree of urgency is assigned to the filter 26 regeneration cycle, it can be used in place of the degree of urgency assigned to the trap 24 purge cycle or in addition to the latter degree of urgency.

The decision module 80 can be independent of the fuel supply controller.

1. System for removing SOx (Sulfur Oxide) stored in a NOx (Nitrogen Oxide) trap associated with an oxidation catalyst and placed upstream of a particulate filter in an exhaust line of a motor vehicle engine, upstream being defined as the direction going toward the source of the exhaust gases, this system including a fuel supply controller adapted to execute multiple cycles, including at least:
a regeneration cycle activated in response to receiving a regeneration request, this cycle comprising commanding a device for supplying fuel to the engine cylinders so as to supply the engine with a rich mixture that enables the particulate filter to be regenerated without thereby allowing the SOx to be removed from the NOx trap, and
a NOx trap purge cycle activated in response to receiving a purge request, this cycle comprising commanding the fuel supply device to supply the engine with a lean mixture that makes it possible to raise the temperature inside the NOx trap and maintain it within a temperature range where SOx removal becomes possible, alternating with a rich mixture that enables the SOx stored in the NOx trap to be removed,
wherein, when a purge cycle must be executed immediately before or after a regeneration cycle, the fuel supply controller is adapted to activate only the purge cycle, and to cancel the regeneration cycle.

2. System according to claim 1, for a vehicle that includes a supervisor for the particulate filter adapted to generate the request to regenerate the particulate filter, in which, each time a purge cycle is executed, the fuel supply controller is adapted to transmit to the particulate filter supervisor an information unit indicating that a purge cycle has been executed, this information altering the instant or the content of the next regeneration request generated by the particulate filter supervisor.

3. System according to claim 1, in which the system has a purge request generator adapted to set the value of a degree of urgency assigned to the purge cycle, this degree of urgency being adapted to take at least two different values, namely, a value corresponding to a low level of urgency and a value corresponding to a higher level of urgency, and to associate the degree of urgency established with the purge request being sent to the fuel supply controller, and in which the fuel supply controller is adapted to plan the instant at which the purge cycle is executed according to the degree of urgency received.

4. System according to claim 3, wherein the fuel supply controller is adapted to immediately execute the purge cycle in response to receiving a purge request associated with a degree of urgency whose value is greater than a preset threshold.

5. System according to claim 1, wherein the fuel supply controller is adapted to execute a regeneration cycle only if no purge cycle must be executed immediately after or before.

6. System according to claim 1, wherein the fuel supply controller is adapted to delay running the purge cycle until it receives a regeneration request for the particulate filter, and in response to this regeneration request, to activate only the purge cycle.

7. System according to claim 1, wherein the fuel supply controller is adapted to delay running the particulate filter regeneration cycle until it receives a purge request, and in response to this purge request, to activate only the purge cycle.

8. Fuel supply controller that can be implemented in a SOx removal system according to claim 1, wherein when a purge cycle must be executed immediately before or after a regeneration cycle, the fuel supply controller is adapted to activate only the purge cycle, and to cancel the regeneration cycle.

9. Method for removing SOx stored in a NOx trap associated with an oxidation catalyst and placed upstream of a particulate filter in an exhaust line of a motor vehicle engine, upstream being defined as the direction going toward the source of the exhaust gases, this method comprising:
executing a regeneration cycle activated in response to receiving a regeneration request, this cycle comprising commanding a device for supplying fuel to the engine cylinders so as to supply the engine with a rich mixture that enables the particulate filter to be regenerated without thereby allowing the removal of the SOx stored in the NOx trap, and
executing a purge cycle activated in response to receiving a purge request, this cycle comprising commanding the fuel supply device to supply the engine with a lean mixture that makes it possible to raise the temperature inside the NOx trap to a temperature at which SOx removal becomes possible, alternating with a rich mixture that enables the SOx to be removed,
wherein when a purge cycle must be executed immediately before or after a regeneration cycle, the method has a planning stage for the cycles to be executed, in which the purge cycle is activated, while the regeneration cycle is canceled.

10. Information recording medium which has instructions for executing a SOx removal method according to claim 9, when these instructions are executed by an electronic computer.
